(19) United States
(12) Patent Application Publication
(10) Pub. No.: US 2025/0014471 A1
(43) Pub. Date: Jan. 9, 2025

(54) All-In-One Learning System (AIOLS)

(71) Applicants: Sunil Herath, Dix Hills, NY (US); Ramin Herath, Dix Hills, NY (US)

(72) Inventors: Sunil Herath, Dix Hills, NY (US); Ramin Herath, Dix Hills, NY (US)

(21) Appl. No.: 18/765,183

(22) Filed: Jul. 5, 2024

Related U.S. Application Data
(63) Continuation of application No. 63/511,928, filed on Jul. 5, 2023.

(51) Int. Cl. G09B 5/06; G06K 19/06; G09B 5/12

(52) U.S. Cl. CPC G09B 5/065; G06K 19/06037; G09B 5/125

(57) ABSTRACT

This invention creates a system that integrates interactive and dynamic content in multiple modalities through the use of QR codes within printed educational materials such as textbooks, lab manuals, workbooks, and other materials. This system allows textbooks to become part of the growing digital educational landscape and gives students a whole new toolbox of content to enhance their learning experience.

### CROSS-REFERENCE TO RELATED U.S. APPLICATIONS

This application claims benefit from, and priority to, U.S. Utility Patent No. US 2017/0337843 A1 published Nov. 23, 2017, which is hereby incorporated by reference in its entirety.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### FIELD OF INVENTION

The present application relates to textbooks, lab manuals, workbooks, and other educational materials, including digital interactive learning material embedded in the printed book.

### BACKGROUND OF INVENTION

The college textbook industry has traditionally offered printed textbooks, which include materials such as lab workbooks, packets, etc. However, the rise of electronic and online learning options is expanding the horizon of learning potential with high-yield learning opportunities.

These modalities have expanded at an accelerated rate since the COVID-19 pandemic in 2020, which permanently transformed education, especially at the collegiate level. The use of digital interfaces became necessary for students to encounter the same amount of content as they would under normal circumstances. The use of these digital materials became the new norm, even as the pandemic eased across the world. As a result, the industry must embrace digital learning materials to keep students engaged while giving the most equitable access possible.

The college textbook industry has also become obsolete in its current state. By only having what is physically in the textbook being the only material that is approved by the instructor creates restrictions on how useful the textbook is. In addition to this, textbooks can only express information in either text, image, or diagram form to convey information. These images and diagrams are also constricted to two dimensions within the textbook. With the advances in modern educational devices today, textbooks cannot be the end-all of information for a class any longer. This invention seeks to address the limitations of present-day textbooks.

Even before the COVID-19 pandemic struck, students entering college through the past decade had grown up with electronic devices and digital learning methods such as Google searching, Wikipedia research, etc. As time has gone on, these students have become further dependent on these devices and modalities, and as a result, a gap has formed between the use of physical textbooks and students' learning from these textbooks. This invention aims to bridge this gap.

### BRIEF SUMMARY OF INVENTION

The present invention provides digital material inside the textbook, which can be accessed by scanning the QR codes printed in the textbook. This system, All-In-One Learning System (AIOLS), combines conventional textbooks with Engaging Learning Materials (ELM) using multiple Quick Response (QR) codes. The ELM that is found in AIOLS is categorized into two different forms. The first category is Learning Management System (LMS) content. This includes but is not limited to an AI-based virtual instructor, question banks, practice exams, and assessments. In addition to this, there are also non-LMS contents within these textbooks that make up the second category. This includes but is not limited to videos, audios, games, and simulation material. This allows textbooks to become a digital interface while maintaining the ability to have a physical textbook. Students can access the ELM by scanning the QR code with their mobile devices as a convenient way of learning. Each QR code directs the student to a specific ELM based on the assigned URL. On the side of the instructor, both LMS and non-LMS materials are customizable based on the instructor's preference. In addition to this, a printed instructor's copy is provided for each course and comes with an LMS instructor account with administrator permissions.

One major feature of AIOLS is the ability to have a changeable QR code. This means that future changes of the content within each QR code can change without changing the printed textbook by the QR code's short URL destination. Finally, all materials are accessible through mobile or any other devices with internet access, making AIOLS very accessible as long as you have a device with a camera and internet connection.

### BRIEF SUMMARY OF DRAWINGS

FIG. 1 is a visual representation of how our invention is incorporated into the physical textbook and the variety of features it has.

FIG. 2 is a breakdown of all the different content (ELM) that can be accessed via QR codes.

FIG. 3 is a diagram illustrating the comparisons between the mechanisms of learning traditionally and with our invention:

FIG. 4 is an application of our invention in the context of a user encountering a new equation using our invention.

FIG. 5 describes the process on the back end of what happens when a user scans a QR code.

FIG. 6 describes the mechanism behind how short URLs are both created and maintained, in the case that the administrator desires a change in content.

### DETAILED DESCRIPTION OF THE INVENTION

The invention relates to the use of technology within physical writing material to transform the way textbooks, such as lab workbooks, packets, etc., are used and how education uses them within the class setting.

There are a variety of terms that are used within the figure drawings to illustrate new technologies that are being presented. The first is AIOLS (All-In-One Learning System), which refers to the entire invention that involves the printed educational material such as textbooks, the QR codes within the text, the URL mechanisms that direct the user to the correct content, as well as all the content that is within the printed educational material and QR codes. This content will be referred to as ELM (Engaging Learning Material). Finally, there will be references to LMS (Learning Management System), an essential part of ELM. The terms “student” and “user” will be used interchangeably. The terms “printed educational material” and “textbook” will also be used interchangeably to describe the variety of forms AIOLS applies to.

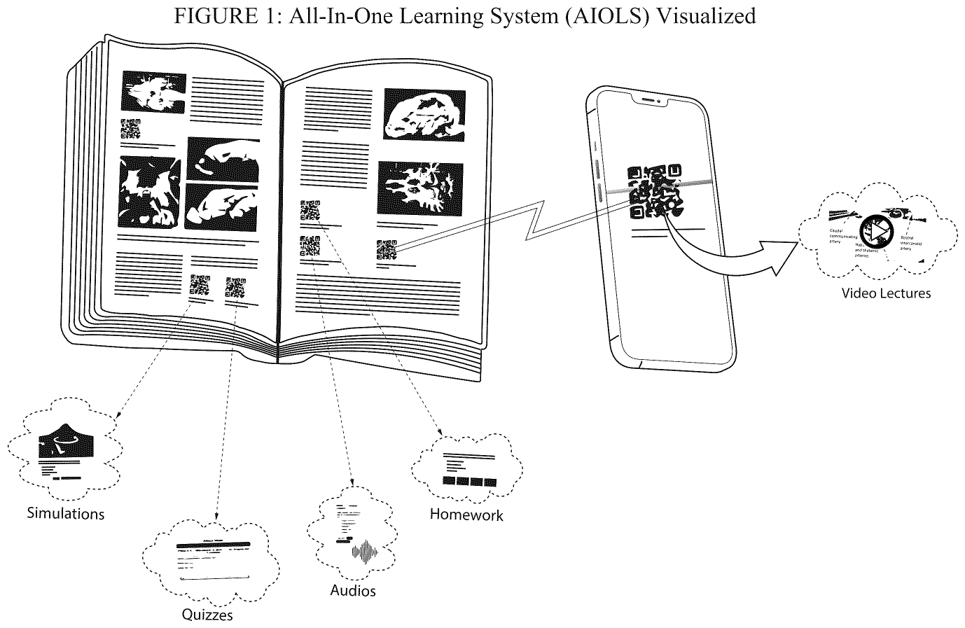

Turning to the drawings now, FIG. 1 visually demonstrates how the invention is incorporated within a textbook, where QR codes are incorporated into the physical book to access new, dynamic ELM (1). Our invention creates another layer of engaging learning material that clarifies, enhances, and creates high-yield learning opportunities, embedding it with a two-dimensional bar code or QR code. The ELM comes in various modalities for the user to interpret the content and is seamlessly incorporated into the physical textbook (2).

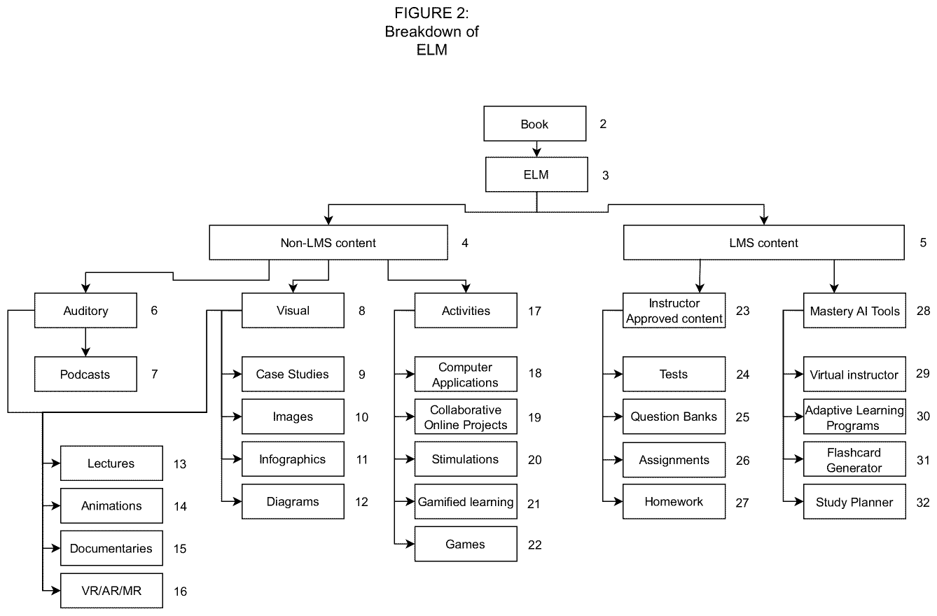

FIG. 2 addresses the various forms of ELM (3) and breaks them down into their LMS (5) and non-LMS (4) forms. Non-LMS content is divided into three categories: auditory, visual, and activities. These activities actively involve learners physically and mentally, helping them grasp long-term concepts, understand them better, and better prepare for LMS activities. Strictly auditory content (6) includes but is not limited to, podcasts (7) and audio notes, while strictly visual content (8) includes but is not limited to case studies (9), images (10), infographics (11), and diagrams (12). There is also an overlap of content that is both auditory and visual, which includes, but is not limited to, lectures (13), animations (14), documentaries (15), and various digital reality modalities such as virtual reality (VR), augmented reality (AR), and mixed reality (MR) (16). Finally, non-LMS content also falls into the category of activities (17), which includes, but is not limited to, computer applications (18), collaborative online projects (19), simulations (20), gamified learning (21), and games (22).

LMS content is divided into two categories: instructor-approved content (23) and mastery AI tools (28). This content provides opportunities to verify the knowledge accumulated through non-LMS activities or self-studies and apply their knowledge in future assessments and tests. The instructor-approved content is often assigned per the syllabus and academic accreditations, allowing for effective practice outside the course. Instructor-approved content includes, but is not limited to, practice tests (24), question banks (25), assignments (26), and homework (27) that are assigned by the instructor. LMS content also includes mastery AI tools, which include but are not limited to, content-trained chatbots known as virtual instructors (29), adaptive learning programs such as problem sets (30), flashcard generator (31), and a study planner (32).

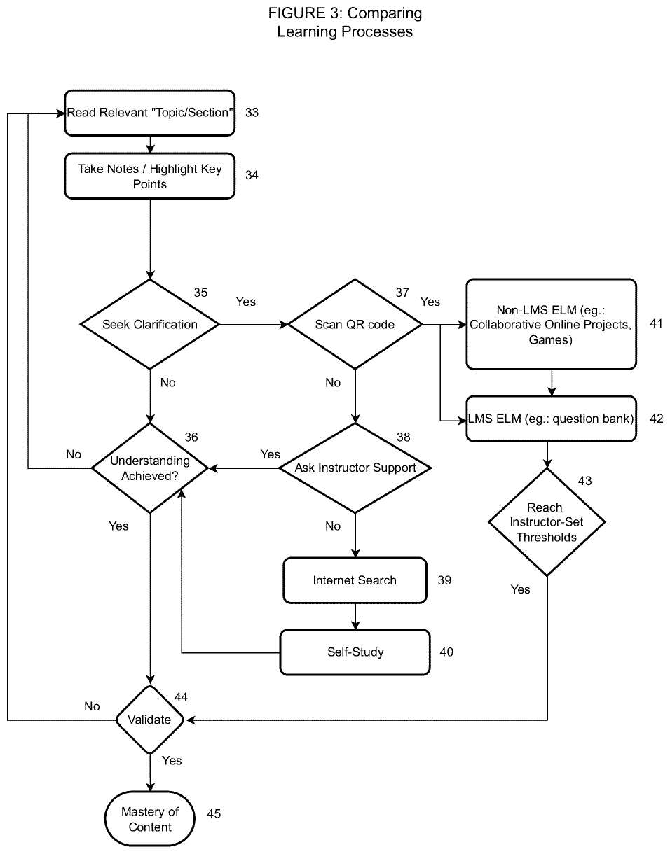

FIG. 3 compares the traditional learning process with conventional textbooks and the learning process with AIOLS incorporated into these textbooks. Typically, when students are introduced to a new concept or assigned a chapter to read, they will read the relevant section (33) and then take notes and highlight key points of the text (34). From here, the student will seek clarification either by asking for instructor support (38) or through the internet (39) with additional self-study (40) for both options. While 39 has potential and connects with the more relevant content, it could also give mixed content, leading to further confusion. From here, if the student has achieved self-perceived understanding (36), they will likely move on from the content until the validation step of an examination or assessment (44). If the student has yet to achieve a self-perceived understanding of the content, they will likely repeat the previous steps, starting at 33 and working through the same cycle until self-perceived understanding is achieved. From there, the student will either do well on the validation step and have mastered the content (45), or go back through the cycle starting from 33 again. However, with AIOLS, a new pathway of learning emerges that allows for a simplification of the learning process. Students can go through the traditional steps 33-35 and then scan the QR code (37) provided by AIOLS in the printed material. From there, the student can enter either Non-LMS (41) or LMS ELM (42), which gives the student various activities, information, and additional content that can enhance a student's learning experience. 42 specifically can be used as a measure of understanding of content for a student and allows the instructor to set a threshold (43) of either the percentage of correct questions, number of flashcards memorized, etc., to virtually co-sign the student's understanding of that particular piece of content. Once students reach 43, they can reach 44 more confidently than in traditional learning processes, leading to a greater yield of 45.

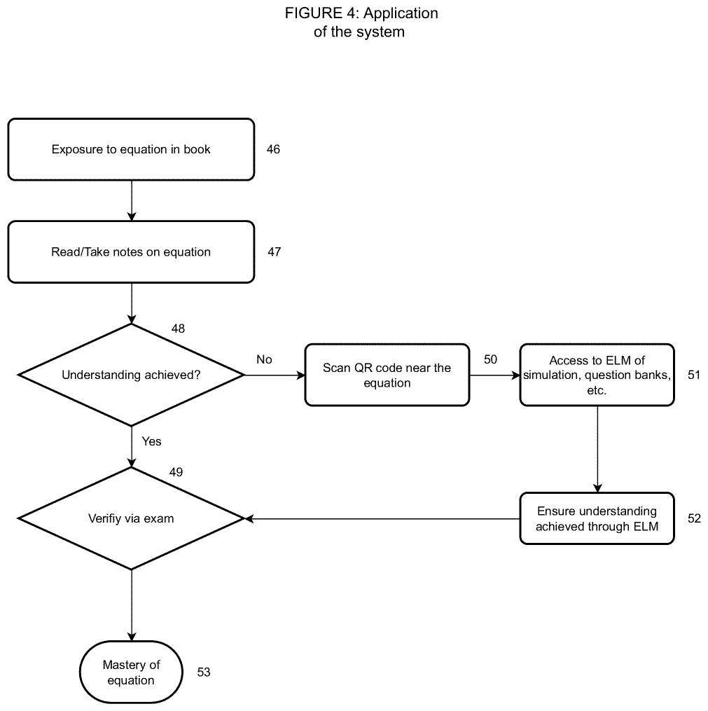

FIG. 4 demonstrates a real-world example of applying AIOLS to a textbook. The student would first encounter an equation in the textbook (46) and then take notes or further read about it (47). At this point, if the student achieves self-perceived understanding (48), they will likely move on to other content until they verify mastery through an assessment in class (49). However, if a student has any questions or confusion about the equation, they will be able to scan the AIOLS QR code that accompanies the new equation (50), which will give the student access to a variety of materials that will allow them to interpret the equation in a variety of modalities such as simulations using the equations and question banks using the equation (51). From there, the student can then access their understanding of the material through additional ELM, such as the LMS materials mentioned before (52), which can lead to a higher yield of students who achieve mastery of the equation (53).

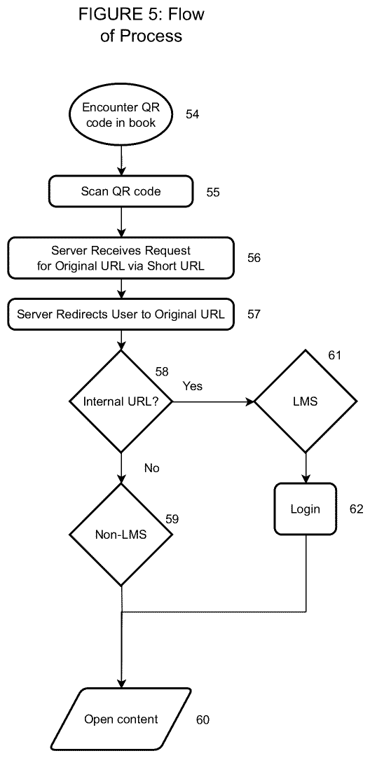

FIG. 5 refers to the mechanism of scanning an AIOLS QR code. First, the user encounters (54) and scans (55) the QR code in the printed material. Under the QR code, the short URL is printed below for the rare event that the QR mechanism cannot work or if the user prefers to input the short URL into an internet browser. Once detected, a notification will appear with the URL and the server receives a request for the original URL of content via the short URL (56). When a server receives a request for an original URL via a short URL, it first extracts the short URL identifier from the request. It then queries its database or lookup table to find the corresponding original URL. Once the original URL is retrieved, the server sends an HTTP 301 (permanent) or 302 (temporary) redirect response back to the client's browser, including the original URL in the Location header. The client's browser automatically follows this redirect and sends a new request to the original URL (57). If the original URL is an internal URL (58), the user will be directed to an LMS (61), where they will be required to log in with credentials (62) to access the ELM (60). If the original URL is not internal, the user will be directly directed to the non-LMS material (59,60).

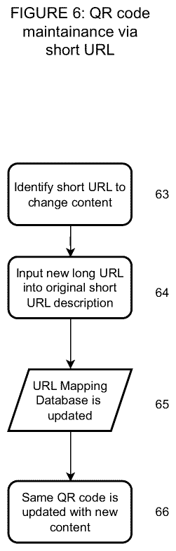

FIG. 6 represents the maintenance of short URLs if the content needs to be changed due to technical difficulties or updates in content. This starts with the instructor contacting the administrator about updating a certain QR code, who will go through the mechanism displayed in FIG. 6. The administrator first identifies which short URL is associated with the QR code within the database (63). Once identified, an updated content link is found and inputted into the description for the short URL being updated (64). From there, the URL mapping is stored in the URL mapping database (65). This results in the same QR code being able to redirect to updated content (66). This function is essential to AIOLS as it allows for outdated or malfunctioning content to be periodically updated when necessary to ensure students receive up-to-date content.

What is claimed is:

1. A method of an All-In-One Learning System (AIOLS) comprises QR codes with a short URL below in printed educational material such as textbooks; the associated content the QR codes direct to is known as ELM, which is divided between non-LMS and LMS content.

2. The AIOLS of claim 1, where the QR code within the printed material enables access to the relevant material via scanning of the QR code with a mobile device.

3. The AIOLS of claim 1, which comprises of access to ELM, can be categorized as Non-LMS content, including auditory, visual, audio-visual or activities including podcasts, lectures, animation, documents, VR/AR/MR, case studies, images, infographics, diagrams, computer applications, collaborative online projects, simulations, gamified learn and games; and LMS content, which includes both instructor-approved content and mastery AI tools, including tests, question banks, assignments, homework, virtual instructor, adaptive learning programs, flashcard generator, and study planner.

4. The AIOLS of claim 1, comprises of QR codes that can be modified to direct to updated content even after the QR code is published in the printed material via short URL modification.
